(19) United States
(12) Patent Application Publication
(10) Pub. No.: US 2023/0211445 A1
(43) Pub. Date: Jul. 6, 2023

(54) ROUTING JIG AND TENON FASTENER FOR CREATING CONCEALED MORTISE AND TENONS

(71) Applicant: Philip Hunter Miller, Mahomet, IL (US)

(72) Inventor: Philip Hunter Miller, Mahomet, IL (US)

(21) Appl. No.: 17/566,865

(22) Filed: Dec. 31, 2021

(51) Int. Cl. B23Q 9/00; B27C 5/10; B27F 5/02; F16B 12/12

(52) U.S. Cl. CPC B23Q 9/0007; B27C 5/10; B27F 5/02; F16B 12/125

(57) ABSTRACT

A routing jig and tenon fastener comprising of a jig that has a means to index a router the proper pathway to create a mortise in any object, and a means for indexing and installation of a corresponding tenon, specifically a routing jig and tenon fastener that is easily maneuverable, fixed or adjustable, in a form being an adjustable routing jig being comprised of a mortise mounting member and an adjustable indexing member, with different sizes and quadrilateral shapes to allow for smaller or larger mortise to be carved out by a router tool, the ability to index on a corner or edge where a mortise can be created, with means to attach the jig to the surface which allows the jig becomes a guide for a router tool to create a mortise, wherein the jig can be used as an indexing guide for aligning and attaching the uniquely and specifically designed quadrilateral tenon fastener for the mortise created by the routing jig, the tenon designed with specific holes, slots, grooves, or mounting options for attaching table legs or other objects, and the specifically placed holes, slots, and grooves allow for different sized screws and fasteners to be installed flush to the tenon.

### CROSS REFERENCE TO RELATED APPLICATIONS

Not Applicable.

### FEDERALLY SPONSORED RESEARCH AND DEVELOPMENT

Not Applicable.

### PARTIES TO A JOINT RESEARCH AGREEMENT

Not Applicable.

### REFERENCE TO MICROFICHE APPENDIX CONTAINING

Not Applicable.

### COMPUTER PROGRAM

Not Applicable.

### BACKGROUND OF THE INVENTION

The present disclosure relates to a routing jig and tenon fastener for creating concealed mortise and tenon joints. The use of this routing jig and tenon fastener can be applied to many objects and fixtures that need to be joined together. One example is attaching a table leg to a tabletop.

A mortise and tenon joint connect two pieces of wood or other material. Woodworkers have used mortise and tenons for thousands of years to join pieces of wood, mainly when the adjoining pieces connect at right angles. A mortise and tenon is also used in construction of buildings, furniture, or other household items.

In today’s world there are many methods for attaching a table leg or object to a table or surface and there are many brackets, fasteners, and corner plates on the market. A current example is Patent No.: U.S. 6,629,506 B2, Park, 2003 (“the ‘506 Patent”). The ‘506 Patent uses a threaded male and female coupling. The fasteners in the ‘506 Patent is exposed and visible. However, there are some situations that require the fastener to be hidden, attached to the very edge or the center of an object or the ability to join any two objects together using a mortise and tenon joint. This patent does not address these issues or situations.

There are other mortis and tenon methods to achieve a mortise and tenon joint, one example is Patent No: U.S. 10,690,164 B2, Stapleton, 2020 (“the ‘164 Patent”). The ‘164 Patent uses a more traditional approach using threaded holes in a tenon and fasteners a large screw to join two objects together. The ‘164 Patent method for joining two objects is mainly for large architectural construction and can be applied to smaller household products. However, the ‘164 Patent requires specific holes to be drilled at very precise locations. The ‘164 Patent leaves the fastener visible and the proper indexing and alignment of the mortis and tenon into the cavity unanswered. As shown by these examples and the ones that follow, existing methods of mortis and tenon joinery have limitations and are not suitable for the various situations as will be disclosed by the claimed invention.

First, traditional wood-to-wood mortise and tenon joinery requires a skilled craftsperson in the trade to cut the mortise and matching tenon. The challenge with using the traditional method is not every person can master these traditional skills as they take time and years to master. The cutting process is often very time consuming and meticulous, and a process that is not suited for novice, do-it-yourselfers, or mass production.

Second, wood-to-wood mortise and tenon joints are often large and can be visible. There are limitations in how deep or shallow a mortis and tenon can be created before the object receiving the mortise is structurally compromised.

Third, wood-to-wood mortis and tenon joints often use glue and other adhesives in addition to the joinery to ensure the mortise and tenon remain together. These additional adhesives add time, cost, and complexity to the joinery, and are permanent.

Fourth, metal-to-wood mortise and tenon connections require metalworking skills, woodworking skills, specific tools, and machinery, or metalworking tools. Therefore, metal-to-wood mortise and tenon connections tend to be a very costly and time-consuming.

Fifth, wood-to-wood joints are not as weather-resistant as metal-to-metal, metal-to-wood or synthetic plastics. Wood-to-wood joints will shrink or expand with varied weather, humidity and temperatures and therefore have the potential to leave a gap between the joints which may lead to further weakening of the joint.

Sixth, the position and location of a traditional mortise and tenon joint is limited by the object’s size or mass, the mortise position, and the second object position or mass. Mortis and tenons are often joined at ninety (90) degrees and require the mortis depth to be deep, and the tenon to be equal in length to the mortis depth.

Seventh, mortis and tenon joints are not designed to come apart, or to be easily disassembled. Therefore, the claimed invention has the advantage of being and reassembled repeatedly in instances, for example, of ease of transportation. Traditional mortise and tenon joints, on the other hand, are meant to stay joined together.

The current state of the art for attaching objects to another object involve the use of angled brackets with a combination of screws or corner plates. Dowls or threaded male-to-male screws can also be used. In all these approaches, one can see the fastener, and most of these techniques require glue. The current state of the art fasteners have limits to how an object can be attached to another object.

For example, a carpenter may want to build a table where the table legs are flush with the edge of the table or there is no visible fastener. In such an example, the carpenter would have to create a mortise and tenon using traditional methods of chiseling and carving out the mortise and tenon or use one of the known mortises and tenon joinery methods. Such methods include boring a mortise at the end of an object and then threading inserts, dowels, or biscuits to function as a mortise and tenon joint. Such methods create several issues such as requiring additional tools, skill, precision, custom jigs, and glue, and are often permanent. Further, using threaded inserts, pocket holes and screws, or dowls to join two objects together take time and labor, precision, additional woodworking or metalworking machinery, and tools to complete.

The method of using a long-threaded bolt, dowl or screw fastener requires the screws or dowls to be inserted into a table leg and then into a tabletop. Using a long-threaded bolt, dowl or screw fastener often creates a male and a female connection, and accordingly requires the craftsman to perfectly align and drill or bore out the holes in each object so they perfectly match up and join together properly.

In commercial applications, there are often industrial jigs and templates that assist with drilling and boring out holes in specific locations where the male and female connection join together. Large manufacturers have mastered this industrial jig and template method on a massive scale. However, these types of methods are out of reach for most consumers and businesses.

A non-traditional method that could be used to create a mortise and tenon is a router. A router is a power tool with a flat base and a rotating blade extending past the base. The spindle may be driven by an electric motor or by a pneumatic motor. The router routs, or hollows out, an area in hard material, such as wood or plastic. Routers are used most often in woodworking, especially cabinetry. Routers may be handheld or affixed to router tables.

If a carpenter or manufacturer wanted to make a mortise or tenon using a router, that craftsperson or manufacturer would have to create a jig to enable the router to travel along a specific path to cut out a mortise. Creating jigs is nothing new to a woodworker, as it is a common practice in the woodworking and manufacturing industry. The claimed invention is unique because it lowers the skill barrier of entry for using a jig for creating mortise and tenons joints. One need not be a woodworker or a manufacturer to create a mortise and tenon joint. The claimed routing jig and tenon fastener is for anyone desiring to make a mortise and tenon joint. The claimed routing jig and tenon fastener can create and install shallow mortises and tenons that would otherwise be structurally impossible to make using traditional methods. The claimed routing jig and tenon fastener can create mortise and tenon joints in any object or surface, like plastics, metals, and other materials. The claimed routing jig and tenon fastener expands the use and creation of mortise and tenon joints from traditional carpentry into everyday objects and applications. In addition, The claimed routing jig and tenon fastener saves the carpenter time and provides the carpenter options in what size mortise and tenon he or she may need for their project. This is possible because the routing jig can be fixed, or non-adjustable, or can also come in an adjustable embodiment in which two or more different sized tenon fasteners can be used in conjunction with the adjustable routing jig. The claimed routing jig and tenon fastener is unique in that the routing jig is also used to index and install the tenon, making the claimed invention a perfect mortise and tenon for anyone who wants to use the mortise and tenon joinery method.

A non-adjustable fixed routing jig can be formed by a fixed square plate material that in most cases would be made out of metal for durability but could be made out of various materials depending upon property characteristics such as weight, hardness, durability, ease of manufacture or cost. Such materials could be metal, wood, carbon fiber, plastic, or a host of natural, synthetic, or composite materials. The non-adjustable fixed routing jig would then have a means to index jig on a corner or edge of the flat piece of material, such as indexing tabs, a lip or a rail where the mortise can be created by a router tool, and the means to attach the routing jig to said flat piece of material to form a stable platform for the router tool, such as plurality of screw holes, slots or grooves.

In an adjustable form, the routing jig is comprised of an adjustable mortise mounting member and an adjustable indexing member. The adjustable mortise mounting member would have a plurality of plurality of screw holes, slots, or grooves to attach the adjustable mortise mounting member to a solid surface such as a tabletop. The adjustable mortise mounting member also has a plurality of grooves, notches, and lips to connect the adjustable mortise mounting member and the adjustable indexing member. The adjustable indexing member also contains a plurality of indexing tabs to properly align and index the routing jig on a solid surface, such as a tabletop. The adjustable indexing member also contains a plurality of grooves, notches, and lips to connect the adjustable indexing member to the adjustable mortise mounting member.

There is another non-traditional method that could be used being a computer numerical control (CNC) system. A CNC machine is a motorized maneuverable tool often incorporating a motorized maneuverable platform both of which are controlled by a computer according to specific input instructions. Instructions are delivered to a CNC machine in the form of a sequential program of machine control instructions. In this example, a programmer could program the CNC machine with instructions to carve out a mortise. The limitation with this method is that the size of the CNC path and object being milled is constrained. Installing and joining the object together are left unanswered. In addition, CNC systems are large, technically challenging, and expensive systems for creating a mortise and tenon joint which leave indexing and installation unresolved. Therefore, the claimed routing jig and tenon fastener for creating concealed mortise and tenons is superior to the CNC tool because the claimed invention solves the large, expensive and complex problem of using a CNC, and simplifies the creation of mortise and tenons and, at the same time, provides the mortise and tenon joinery method to everyone at a cheaper more affordable price.

The claimed routing jig and tenon fastener for creating concealed mortise and tenons on any object eliminates or minimizes limitations with conventional and nonconventional mortise and tenon joinery. Through research and development, the following routing jig and tenon fasteners, process and methods described below have been developed.

### BRIEF SUMMARY OF THE INVENTION

The routing jig and tenon fastener and method for creating concealed mortise and tenons includes a routing jig for creating the mortise, and a tenon fastener. These two elements of the embodiment work together to form a mortise and tenon joint, being the fastener connection.

The routing jig is easily maneuverable and can be fixed or non-adjustable having a sing sized and corresponding tenon fastener, or the routing jig can be adjustable to different sizes and quadrilateral shapes to allow for a smaller or larger mortise to be carved out by a router tool. The routing jig also has the ability to index and self-center on a corner or edge where a mortise can be created. The jig includes a means to attach the routing jig to any surface, and therefore the routing jig becomes a guide for a router tool to create a mortise in the attached surface.

The routing jig is also used as an indexing guide for aligning and attaching the uniquely designed quadrilateral tenon fastener to an object’s surface. The tenon fastener allows, for example, a table leg to become a perfect tenon for the mortise created by the routing jig. Using the routing jig to create the mortise and as a guide to attach the tenon fastener to any object’s surface allows the tenon fastener to be concealed from sight. The tenon fastener is designed to fit into the mortise created by the routing jig, thus creating a perfect mortise and tenon joint and union of the two objects.

The tenon fastener is uniquely designed and engineered to work in conjunction with the routing jig. The tenon is sized to fit within the quadrilateral mortise created by the routing jig. The tenon also has been engineered with specific holes, slots, and grooves as mounting options for attaching table legs or other objects that need to have a mortise and tenon joint. The specifically placed holes, slots, or grooves allow for different sized screws and fasteners to be installed flush to the tenon fastener. The tenon fastener can be made from steel, plastic, or other material.

The routing jig and tenon fastener for creating concealed mortise and tenons allows unexperienced woodworkers or manufacturers to create a concealed mortise quickly, accurately, and more affordably than other techniques known in the industry and in the marketplace. The routing jig assists in the perfect placement of the tenon fastener so that it can attach to any surface and object that would be almost impossible if one were to use traditional or other non-traditional mortise and tenon joinery.

A summary of the invention in the broadest form is a routing jig and tenon fastener that has a means to index and provide a router the proper pathway to create a mortise in any surface such as a tabletop, as well as an indexing and installation guide for a attaching a corresponding quadrilateral tenon fastener to an object such as a table leg. This routing jig and tenon fastener allows any object to be joined together using the mortise and tenon joinery method.

### BRIEF SUMMARY OF THE PROCESS AND METHOD

The routing jig and tenon fastener process and method create a new way for a carpenter, metal worker, furniture maker, or do-it-yourselfer to create, build and assemble mortise and tenons joints. This method does not require any traditional training in the woodworking or metal working arts. The routing jig and tenon fastener process and method expands the accessibility and adoption of mortise and tenon joints to more individuals and products because the invention has simplified the process for creating and applying mortise and tenons to objects.
1. Determine the quadrilateral shape, size, and location of the of the mortise and tenon joint;
2. Adjust or select the correct quadrilateral shape and size of the routing jig for the desired size of the mortise and tenon joint;
3. Align and index the routing jig using the indexing tabs and guides to the location of the mortise and tenon joint on a flat surface;
4. Secure the routing jig to the flat surface receiving the mortise;
5. Index the router to the correct depth of the mortise and the tenon fastener;
6. Use the routing jig as a stable platform and guide for the router tool to move along the quadrilateral path to cut the mortise on the flat surface receiving the mortise;
7. Remove the routing jig from the flat surface receiving the mortise;
8. Attach the routing jig to the object receiving the quadrilateral tenon fastener using the indexing tables to align the object receiving the tenon fastener;
9. Select the corresponding sized quadrilateral tenon fastener to the quadrilateral sized mortise;
10. Place and secure the tenon fastener to the flat surface that received the mortise using the indexing tabs on the routing jig as an indexing and alignment guide;
11. Secure the tenon fastener to the object receiving the tenon fastener on its surface using the plurality of holes, slots, or grooves located in the tenon fastener;
12. Remove the adjustable routing jig from the object receiving the tenon fastener plate;
13. Insert and place the tenon fastener plate into the mortise created by the routing jig on the flat surface that received the mortise; and
14. Secure the tenon fastener plate to the mortise using the plurality of screw holes, slots or grooves.

### BRIEF DESCRIPTION OF THE DRAWINGS

For fuller understanding of the nature and object of the invention, reference should be made to the following details description taken in conjunction with the accompanying drawings in which:

FIG. 1 is an analyzed, exploded perspective view for illustrating an example non-adjustable routing jig, tenon fastener, table leg and a tabletop with a carved-out mortise;

FIG. 2 is a side view for illustrating an example tenon fastener;

FIG. 3 is a perspective view for illustrating a tenon fastener;

FIG. 4 is a top view for illustrating the tenon fastener;

FIG. 5 is a bottom view for illustrating a tenon fastener;

FIG. 6 is a side view for illustrating an example non-adjustable routing jig;

FIG. 7 is a top perspective view for illustrating an example non-adjustable routing jig;

FIG. 8 is a top view for illustrating a non-adjustable routing jig;

FIG. 9 is a bottom view for illustrating a non-adjustable routing jig;

FIG. 10 is an analyzed, perspective view for illustrating an example non-adjustable routing jig attached and secured to flat surface, being a tabletop as illustrated, with a carved-out mortise;

FIG. 11 is an analyzed, perspective view for illustrating an example non-adjustable routing jig secured to a flat surface, being a tabletop as illustrated, and the position of the indexing tabs for properly indexing, aligning, and carving out a mortise;

FIG. 12 is an analyzed, perspective view for illustrating an example non-adjustable routing jig on a flat surface of a table leg reflecting the indexing tabs to properly index, align and attach an example tenon fastener using a plurality of screw holes;

FIG. 13 is an analyzed, perspective view for illustrating an example non-adjustable routing jig secured to the object, being a table leg as illustrated, and the position of the indexing tabs for properly indexing, aligning, and attaching a tenon fastener;

FIG. 14 is an analyzed, exploded perspective view for illustrating an example adjustable routing jig comprised of an adjustable mortise mounting member and an adjustable mortise indexing member, being demonstrated in concert with a tenon fastener, a table leg, and a tabletop with a carved-out mortise;

FIG. 15 is side view for illustrating an example adjustable mortise mounting member;

FIG. 16 is an analyzed, perspective view for illustrating an adjustable mortise mounting member;

FIG. 17 is a top view for illustrating the adjustable mortise mounting member;

FIG. 18 is a bottom view for illustrating the adjustable mortise mounting member;

FIG. 19 is a side view for illustrating an example adjustable mortise indexing member;

FIG. 20 is an analyzed, perspective view for illustrating an adjustable mortise indexing member;

FIG. 21 is a top view for illustrating the adjustable mortise indexing member;

FIG. 22 is a bottom view for illustrating the adjustable mortise indexing member;

FIG. 23 is a side view for illustrating an example adjustable mortise mounting member attached and connected to an example adjustable mortise indexing member;

FIG. 24 is an analyzed, perspective view for illustrating the adjustable mortise mounting member attached and connected to the adjustable mortise indexing member forming an example adjustable routing jig;

FIG. 25 is a top view for illustrating the adjustable mortise mounting member attached and connected to the adjustable mortise indexing member forming the adjustable routing jig;

FIG. 26 is an analyzed, close-up perspective view for illustrating the adjustable mortise mounting member’s grooves, notches, and lips to the adjustable mortise indexing member’s grooves, notches, and lips;

FIG. 27 is an analyzed, perspective view for illustrating the adjustable mortise mounting member temporarily attached and connected to the adjustable mortise indexing member and secured to a flat surface of a tabletop with a carved-out mortise;

FIG. 28 is an analyzed, perspective view for illustrating the adjustable mortise mounting member attached and connected to the adjustable mortise indexing member secured to a flat surface of a tabletop and the position of the indexing tabs for properly indexing, aligning, and carving out a mortise;

FIG. 29 is an analyzed, perspective view for illustrating the adjustable mortise indexing member on an object being a table leg to properly index, align and attach a tenon fastener using the tenon fastener’s plurality of screw holes, slots, or grooves;

FIG. 30 is an analyzed, perspective view for illustrating the adjustable mortise indexing member on a flat surface of a table leg and the position of the indexing tabs for properly indexing, aligning, and attaching a tenon fastener;

FIG. 31 is an analyzed, perspective view for illustrating an installed tenon fastener that has been properly indexed, aligned, and attached to a flat surface of a table leg ;

FIG. 32 is an analyzed, perspective view for illustrating the location and placement of an attached tenon fastener on a flat surface of a table leg into the mortise cavity created on the surface of a tabletop;

FIG. 33 is a perspective view for illustrating the joining of the tenon fastener to the mortise cavity using a plurality of screw holes, slots, or grooves in the tenon fastener;

FIG. 34 is a perspective view for illustrating the assembly of a single table leg and tabletop using the routing jig and tenon fastener process and method for creating concealed mortise and tenon joints;

FIG. 35 is a perspective view for illustrating the complete assembly of a table leg and tabletop using the routing jig and tenon fastener process and method for creating concealed mortise and tenon joints.

### DETAILED DESCRIPTION OF THE INVENTION

Hereinafter, the preferred embodiments of the present invention will be described in detail with reference to accompanying drawings.

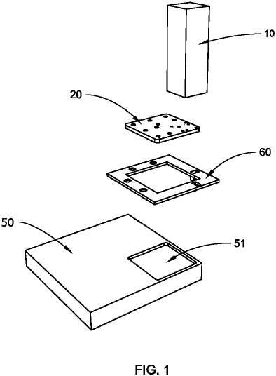

FIG. 1 illustrates an exploded, perspective, upside-down view of a top part of a table leg and tabletop structure in accordance with a fixed (non-adjustable) routing jig and tenon fastener, and the routing jig and tenon fastener process and method, including a table leg 10, a tenon fastener 20, that attaches to the table leg 10, the non-adjustable routing jig 60, and a tabletop surface 50, to which the tenon plate fastener 20 is designed by its quadrilateral shape, size and depth to correspond to the mortise cavity 51 created by the router with the routing jig.

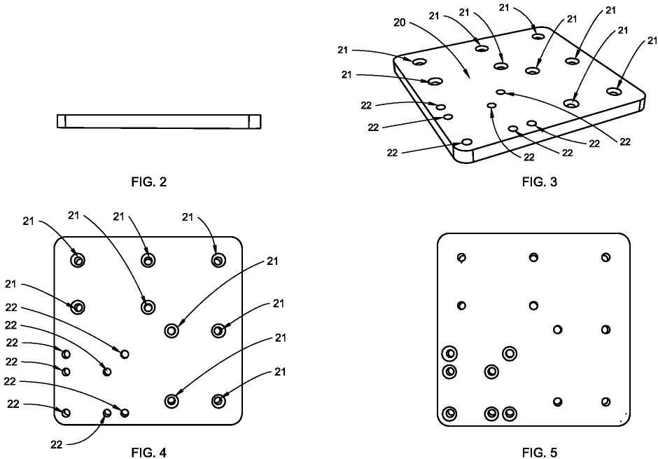

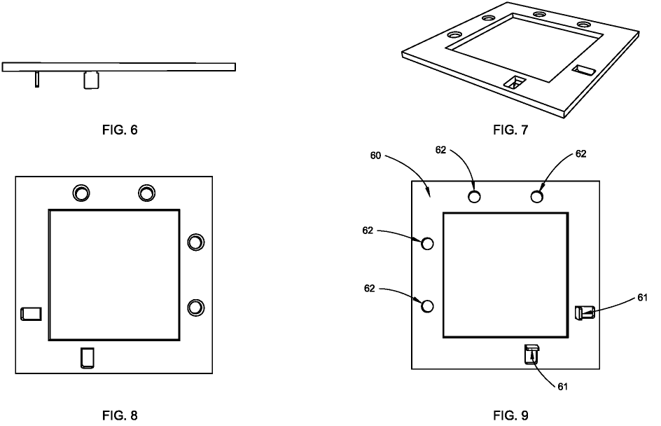

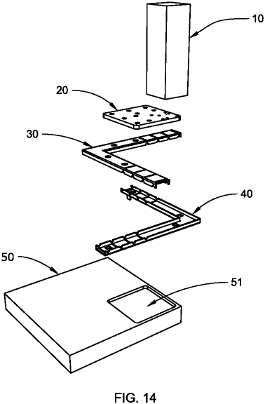

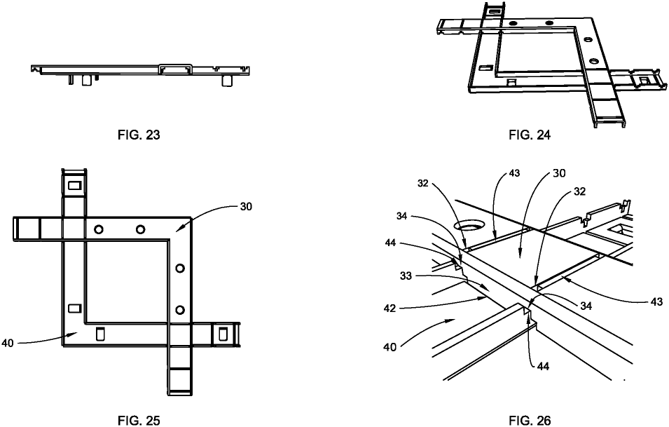

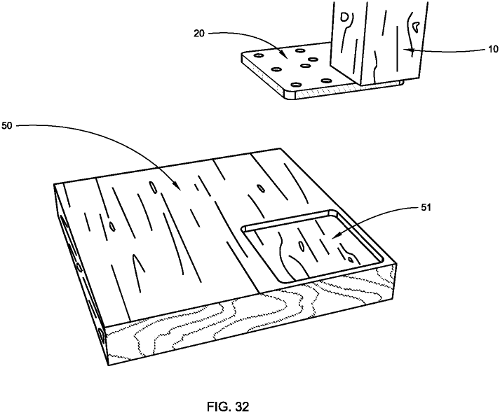

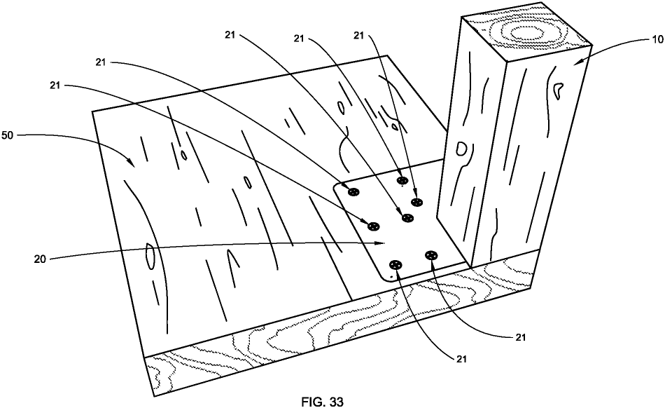

FIG. 2 is a side illustration of the tenon fastener 20. FIG. 3 is a perspective view of the tenon fastener 20 formed from a solid piece of metal in a quadrilateral shape that matches the non-adjustable routing jig 60 shown in FIG. 1, and also shown in FIGS. 7, 8, and 9. The tenon fastener 20 shown in FIG. 3 also matches the shape of the adjustable routing jig shown in FIG. 24, when the two elements of the adjustable mortise mounting member 30 and adjustable mortise indexing member 40 are assembled together to form adjustable routing jig as illustrated in FIGS. 24 and 25. The tenon fastener 20 , as shown in FIGS. 3, 4 and 5, has a plurality of holes, slots or grooves 22, FIG. 3, for attaching the tenon fastener to the surface of an object, an example being a table leg 10 illustrated in FIGS. 12 and 13. FIGS. 12 and 13 further show the use of a non-adjustable routing jig 60, and the use of the indexing tabs 61 as illustrated in FIG. 13. The tenon fastener 20, as shown in FIGS. 32 and 33, also has a plurality of apposing holes, slots, or grooves 21, as shown in FIG. 33, for attaching the tenon fastener 20 to a flat surface such as a tabletop 50. FIG. 4 is a top illustration of the tenon fastener 20 with a plurality of holes, slots, or grooves 22 for fastening the tenon fastener to a flat object, such as a table leg as illustrated in FIG. 31, and a plurality of holes, slots, or grooves 21 for fastening the tenon fastener to a flat surface, such as a tabletop as illustrated in FIG. 33. FIG. 5 is a bottom view of the tenon fastener 20.

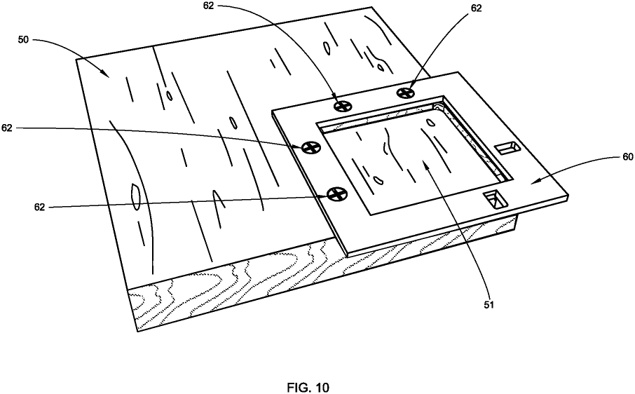

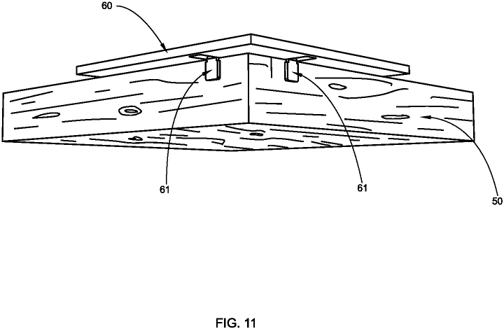

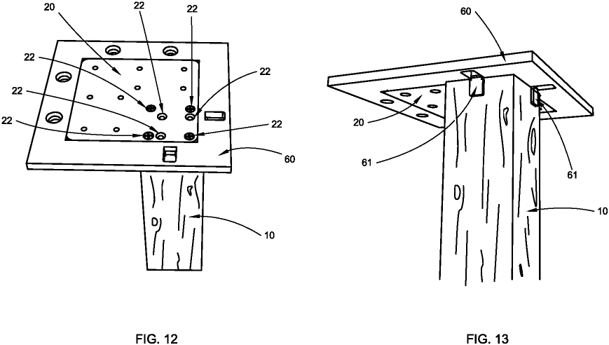

FIG. 6 is a side illustration of the non-adjustable fixed routing jig 60. The non-adjustable fixed routing jig 60 is formed from a solid piece of metal in a quadrilateral shape. FIG. 7 is a perspective view of the non-adjustable fixed routing jig 60. FIG. 8 is a top view of the non-adjustable fixed routing jig 60. FIG. 9 illustrates the plurality of holes, slots or grooves 62 to attach the non-adjustable routing jig 60 to a flat surface, a tabletop as illustrated in FIG. 10. FIG. 9 further illustrates the indexing tabs 61 located on the bottom of the non-adjustable fixed routing jig 60. The indexing tabs 61 properly align and index the non-adjustable fixed jig on the flat surface, a tabletop as illustrated in FIG. 11. Once the non-adjustable fixed routing jig 60 has been properly indexed and aligned to a flat surface such as a tabletop 50, screws are inserted in the screw holes 62 as illustrated in FIG. 10 to temporarily secure the non-adjustable fixed routing jig 60 to the flat surface to provide a guide, pathway and template for a router tool to travel. The non-adjustable fixed routing jig 60 can be used in an assembly line or in mass production for easily carving out mortises and attaching tenons in flat surfaces. This is a process that can be quickly and easily repeated. FIG. 12 is a perspective view for illustrating the non-adjustable fixed routing jig 60 on a flat surface of a table leg 10 to properly index, align and attach a tenon fastener 20 using the tenon fasteners plurality of screw holes, slots, or grooves 22. FIG. 13 is a perspective view for illustrating the non-adjustable fixed routing jig 60 affixed and positioned to a flat object, being a table leg 10 as illustrated, by use of the indexing tabs 61 which serve to properly index, align and attach the tenon fastener 20.

FIG. 14 illustrates an exploded perspective view of a top part of a table leg and tabletop structure in accordance with an adjustable routing jig including a table leg 10, a tenon plate fastener 20, that attaches to the table leg 10, an adjustable mortise mounting member 30, an adjustable mortise indexing member 40, and a tabletop surface 50, to which the tenon plate fastener 20, is inserted into the mortise cavity 51.

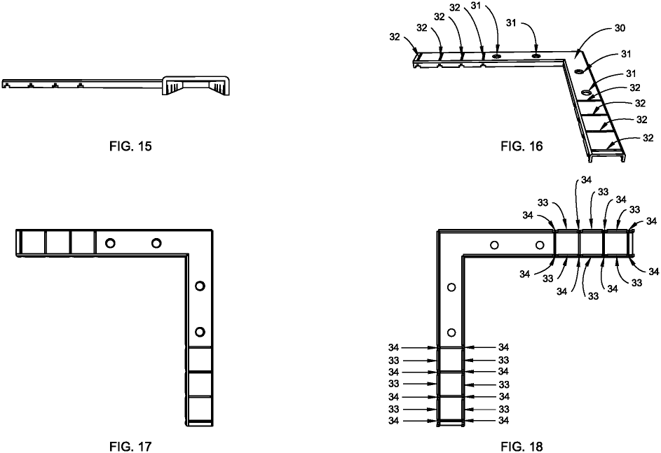

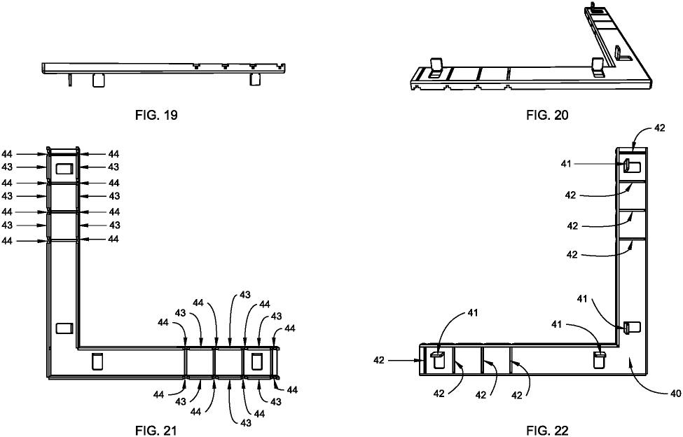

The adjustable routing jig, as illustrated in FIGS. 24 and 25, is formed by two right-angled piece of square metal plate material, being the adjustable mounting mortise member 30, and the adjustable indexing mortise member 40. FIG. 15 is a side illustration of the adjustable mortise mounting member 30. FIG. 16 is a perspective illustration of the adjustable mortise mounting member 30 illustrating the plurality of a plurality of grooves and notches 34 and lips 33 and holes 31. FIG. 17 is a top illustration of the adjustable mortise mounting member 30. FIG. 18 is a top illustration of the adjustable mortise mounting member 30 illustrating the plurality of a plurality of grooves and notches 34 and lips 33.

FIG. 19 is a side illustration of the adjustable mortise indexing member 40. FIG. 20 is a perspective illustration of the adjustable mortise indexing member 40. FIG. 21 is a top illustration of the adjustable mortise indexing member 40 illustrating the plurality of notches 44 and lips 43. FIG. 22 is a top illustration of the adjustable mortise indexing member 40 illustrating the plurality of grooves 42 and the indexing tabs 41.

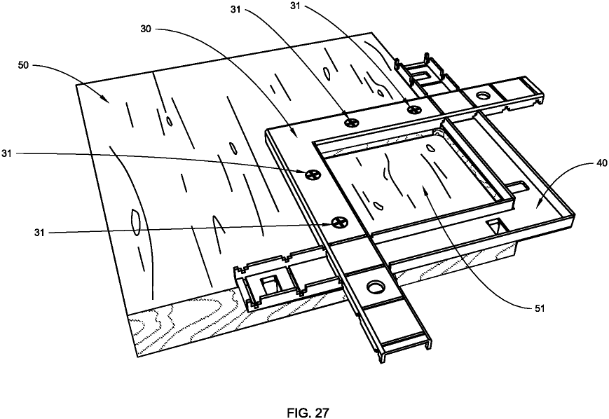

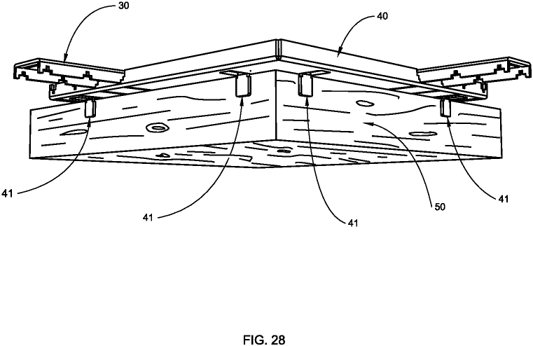

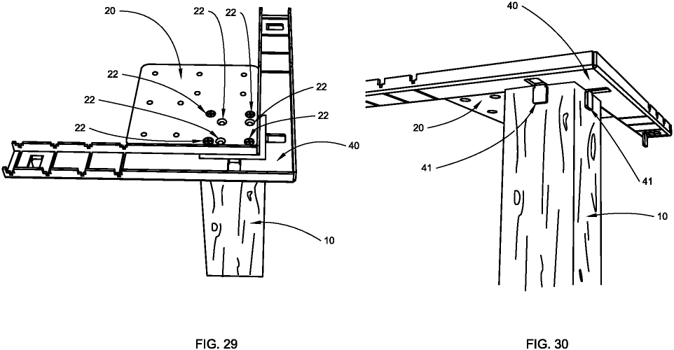

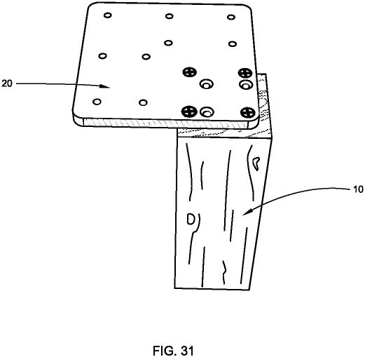

FIG. 23 is a side illustration of the adjustable mortise mounting member 30 and the adjustable mortise indexing member 40. The adjustable mortise mounting member 30 and the adjustable mortise indexing member 40 can be adjusted and joined together as illustrated in FIG. 25 to form an adjustable routing jig. FIG. 24 is a perspective view of the joined adjustable routing jig. The adjustable mortise mounting member 30 and the adjustable mortise indexing member 40 can join at distinct positions to form large or small quadrilateral mortise shapes using the plurality of grooves 32 and 42, notches 34 and 44, and lips 33 and 43 in each of the members as illustrated in FIG. 26. These grooves 32 and 42, notches 34 and 44, and lips 33 and 43 allow the two members to properly index, align, and connect to each other to form the perfect quadrilateral shape as illustrated in FIG. 25 for the router to travel. This creates a repeatable shape and pathway for the router to travel along and carve out a repeatable and perfect sized mortise 51 in a flat surface of a tabletop as seen in FIG. 27.

FIG. 27 illustrates the method of attaching the adjustable mortise mounting member 30 and the adjustable mortise indexing member 40 to a tabletop 50 using the plurality of holes 31 in the adjustable mortise mounting member 30. This method of attaching requires the adjustable mortise indexing member 40 to be placed on the top flat surface of the tabletop 50 and indexed using the indexing tabs 41 as illustrated in FIG. 28. The indexing tabs 41 will properly align and index the jig on the tabletop 50 surface. Once the adjustable routing jig as illustrated in FIG. 24 has been properly indexed and aligned, screws are inserted in the screw holes 31 located on the adjustable mortise mounting member 30. The screws temporarily fasten the adjustable mortise mounting member 30 and adjustable mortise indexing member 40 to the tabletop 50 surface and provide a guide, pathway, and template for the router tool to travel.

Once the jig is temporarily fastened to the tabletops flat surface 50, a router tool can be used to carve out a mortise 51 as illustrated in FIG. 27. The adjustable mortise mounting member 30 and adjustable mortise indexing member 40 create a stable platform and guide for the router tool to move along the quadrilateral path and shape of the joined adjustable mortise mounting member 30 and adjustable mortise indexing member 40, thus allowing the router to carve out and form a perfect mortise cavity 51 for the matching tenon fastener illustrated in FIG. 3. After the mortise has been carved out by a router tool, the adjustable mortise mounting member 30 and adjustable mortise indexing member 40 and can be removed.

FIG. 29 illustrates the indexing and attaching of the corresponding tenon fastener plate 20 to a table leg 10 using the plurality of holes, slots or grooves 22 in the tenon fastener 20. The quadrilateral tenon fastener 20 is designed to work in conjunction with the adjustable mortise indexing member 40 and is used to properly index and align the tenon fastener plate 20 to a flat surface of an object, and in this example and illustration being a table leg 10. Once the quadrilateral tenon plate 20 is properly indexed using the indexing tabs 41 as illustrated in FIG. 30, the plate can be secured to the object’s surface, in this illustration a table leg, using the plurality of holes, slots, and grooves 22. The position of the holes, slots, and grooves 22 in the tenon plate 20 are positioned to allow different sized objects to be attached. FIG. 31 illustrates a fastened tenon fastener plate 20 to an object in this example being a table leg 10.

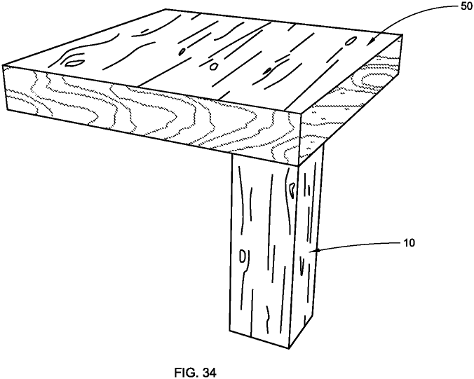

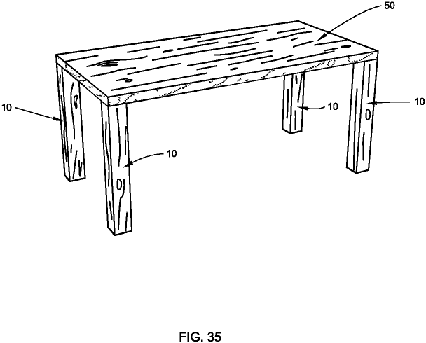

FIG. 32 illustrates a partially exploded view of table leg with an attached tenon fastener plate 20 and a tabletop 50 with a carved-out mortise 51. To complete the mortise and tenon joint, the tenon fastener plate 20 needs to be placed and inserted into the mortise cavity 51 created by the non-adjustable fixed routing jig 60 or created by the adjustable routing jig 25. FIG. 33 illustrates the joining of the tenon plate 20 and table leg 10 to the tabletop within the mortis cavity using the plurality of screw holes, slots or grooves 21. FIG. 34 illustrates an assembled table leg 10 and a tabletop 50 using the routing jig and tenon fastener, and the process and method for creating concealed mortise and tenon joints. FIG. 35 illustrates a fully assembled table using the jig and tenon fastener, and the process and method for creating concealed mortise and tenon joints. The routing jig and tenon fastener, and the process and method for creating concealed mortise and tenon joints as described above properly creates, secures, and joins two objects together using the mortise and tenon joinery method that can be applied to any object or flat surface.

What is claimed is:

1. A routing jig and tenon fastener comprising of:
a non-adjustable fixed routing jig formed by a fixed square plate material allowing a router tool to carve out a mortise in a flat piece of material;
means to index said non-adjustable routing jig on a corner or edge of said flat piece of material where said mortise can be created by said router tool;
means to attach said non-adjustable routing jig to said flat piece of material to form a stable platform for the router tool to create said mortise;
a tenon fastener that matches the specific depth of the mortise carved out by the router tool;
means for indexing and aligning said tenon fastener to an object such as a table leg;
means for attaching said object such as a table leg to said tenon fastener; and
means to attach said tenon fastener, with said object such as a table leg, to the flat piece of material within the mortise carved out by the router tool.

2. The routing jig and tenon fastener, as set forth in claim 1, wherein the means to index the jig on said corner or said edge of said flat piece of material where said mortise can be created by said router tool is achieved by a plurality of indexing tabs bent from said fixed square plate material.

3. The routing jig and tenon fastener, as set forth in claim 1, wherein the means to index the jig on said corner or edge of said flat piece of material where said mortise can be created by said router tool is achieved by adding a lip or a rail to the fixed square plate material, made from a similar material to the fixed square plate material.

4. The routing jig and tenon fastener, as set forth in claim 1, wherein the means to attach the jig to said flat piece of material to form a stable platform for the router tool to create the mortise is achieved by a plurality of screw holes in the fixed square metal plate.

5. The routing jig and tenon fastener, as set forth in claim 1, wherein the means for indexing and aligning said tenon fastener to said object such as a table leg are achieved by a plurality of indexing tabs bent from the fixed square metal plate.

6. The routing jig and tenon fastener, as set forth in claim 1, wherein the means for attaching said object, such as a table leg, to said tenon fastener is achieved by a plurality of countersunk screw holes and screws.

7. The routing jig and tenon fastener, as set forth in claim 1, wherein the means to attach said tenon fastener, with said object attached such as a table leg, to said flat piece of material within the mortise carved out by the router tool is achieved by a plurality of countersunk screw holes and screws.

8. An adjustable routing jig and tenon fastener comprising of:
An adjustable jig formed by a first and a second right-angled pieces of square plate material;
Said first right-angled piece of square plate material being further defined as an adjustable mortise mounting member and having a plurality of grooves, notches and lips which will align together with said second right-angled piece of square plate material;
Said second right-angled piece of square plate material being further defined as an adjustable mortise indexing member and having a plurality of grooves, notches and lips which will align together with said an adjustable mortise mounting member;
Said adjustable mortise indexing member having means to index said adjustable jig on a corner or edge of a flat piece of material, such as a tabletop, where a mortise can be created by a router tool;
Said adjustable mortise mounting member having means to attach the adjustable jig to said flat piece of material, such as a tabletop, to form a stable platform for said router tool to create a mortise;
a tenon fastener that matches the specific depth of the mortise carved out by said router tool;
means for indexing and aligning said tenon fastener to an object, such as a table leg;
means for attaching said object, such as a table leg, to said tenon fastener; and means to attach said tenon fastener, with said object, such as a table leg, to said flat piece of material within the mortise carved out by said router tool.

9. The adjustable routing jig and tenon fastener, as set forth in claim 8, wherein the means to index the jig on a corner or edge of said flat piece of material, such as a tabletop, where said mortise can be created by said router tool is achieved by a plurality of indexing tabs bent from said adjustable mortise indexing member.

10. The adjustable routing jig and tenon fastener], as set forth in claim 8, wherein the means to index the jig on a corner or edge of said flat piece of material, such as a tabletop, where said mortise can be created by said router tool is achieved by a lip or rail to said adjustable mortise indexing member, said lip or rail made from a similar metal to said adjustable mortise indexing member.

11. The adjustable routing jig and tenon fastener, as set forth in claim 8, wherein the means to attach the jig to said flat piece of material, such as a tabletop, to form a stable platform for the router tool to create the mortise is achieved by a plurality of screw holes in said adjustable mortise mounting member.

12. The adjustable routing jig and tenon fastener, as set forth in claim 8, wherein the means for indexing and aligning said tenon fastener to a piece of material such as a table leg are achieved by a plurality of indexing tabs bent from said adjustable mortise indexing member.

13. The adjustable routing jig and tenon fastener, as set forth in claim 8, wherein the means for attaching an object, such as a table leg, to said tenon fastener is achieved by a plurality of countersunk screw holes and screws.

14. The adjustable routing jig and tenon fastener, as set forth in claim 8, wherein the means to attach said tenon fastener, with said object, such as a table leg, to said flat piece of material within said mortise carved out by said router tool is achieved by a plurality of countersunk screw holes and screws.

15. A method for creating concealed mortise and tenon joints, the method comprising the steps of:
Determine the quadrilateral shape, size, and location of the of the mortise and tenon joint;
Adjust or select the correct quadrilateral shape and size of routing jig for the desired size mortise and tenon joint;
Align and index the routing jig to the location of the mortise and tenon joint;
Secure the routing jig to the flat material receiving the mortise;
Index the router to the correct depth of the mortise;
Use the routing jig as a stable platform and guide for the router tool to move along the quadrilateral path to cut the mortise;
Remove the routing jig from the object;
Apply the bottom adjustable mortise indexing member jig to the object receiving the tenon fastener plate;
Select the corresponding sized tenon for the sized mortise;
Place and secure the fastener plate to the object using the bottom adjustable mortise indexing member jig as an indexing and alignment guide. Secure it to the objects surface using the plurality of holes, slots, and grooves located in the fastener plate;
Remove the bottom adjustable mortise indexing member jig from the object receiving the tenon fastener plate; and
Insert and place the tenon fastener plate into the mortise cavity created by the jig. Secure the tenon fastener plate to the mortise surface using the plurality of uniquely placed screw holes, slot, and grooves.

16. The method according to claim 15, wherein the routing jig is a fixed square metal plate material allowing a router tool to carve out a mortise in a flat piece of material.

17. The method according to claim 15, wherein the routing jig is an adjustable jig formed by two right-angled pieces of square metal plate material with a plurality of [grooves and lips] which align together to connect the two right-angled pieces of square metal plate, which when held together allow for a router tool to carve out a mortise in a flat piece of material;.

18. The method according to claim 15, wherein the method to align and index the routing jig to the location of the mortise and tenon joint is a plurality of indexing tabs bent from the fixed square metal plate.

19. The method according to claim 15, wherein the method to secure the routing jig to the object receiving the mortise is a plurality of screw holes in the routing jig.

20. The method according to claim 15, wherein the method to place and secure the tenon to the object using the routing jig as an indexing and alignment guide is a plurality of screw holes in the tenon.
